(19) United States
(12) Patent Application Publication
(10) Pub. No.: US 2009/0217902 A1
(43) Pub. Date: Sep. 3, 2009

(54) METHOD FOR ASSEMBLING A CRANKSHAFT DRIVE AND PISTON COMPRESSOR

(76) Inventor: Michael Hartl, Unterhaching (DE)

Correspondence Address: BARNES & THORNBURG LLP, 750-17TH STREET NW, SUITE 900, WASHINGTON, DC, 20006-4675, US

(21) Appl. No.: 12/064,882

(22) PCT Filed: Aug. 25, 2006
(86) PCT No.: PCT/EP2006/008339

§ 371 Date: Jun. 30, 2008

(30) Foreign Application Priority Data
Aug. 26, 2005 (DE) 102005040496.0

(51) Int. Cl. F02B 75/32; F02F 3/00

(52) U.S. Cl. 123/197.4; 123/193.6

(57) ABSTRACT

A piston compressor includes a crankcase having an interior space. The compressor also includes a crankshaft, at least one connecting rod having a connecting rod head that interacts with the crankshaft. The at least one connecting rod and crankshaft are arranged in the crankcase and the crankcase and the at least one connecting rod are of a non-split configuration to permit assembly of the at least one connecting rod on the crankshaft by a threading into the interior space of the crankcase.

### BACKGROUND AND SUMMARY

The present disclosure relates to a method for assembling a crank drive. The crank drive includes a crankshaft and at least one connecting rod. The crank drive is assembled into a crankcase of a piston compressor. The present disclosure also relates to a piston compressor which may be produced according to the method disclosed herein.

Piston compressors are usually coupled to a drive unit, such as an electric motor, in order, by the rotational movement generated, to compress air by a crank drive and a piston which performs an oscillating linear movement. The piston compressor, which is formed from the piston compressor with a drive unit, is for example used in the automotive field for generating compressed air which is required for the operation of vehicle-specific pressure medium units such as brakes or the like.

DE 101 09 514 C1 discloses a generic piston compressor. The unit is embodied here in the manner of a dry-running piston compressor. The compressor has a crank which is rotatably mounted in a crankcase and which is connected by a crankshaft-side rolling bearing to the connecting rod head of the connecting rod. At the opposite connecting rod eye of the connecting rod, a piston is pivotably mounted on the connecting rod by a piston pin. Overall, this arrangement forms the crank drive. The piston is accommodated in an axially movable fashion within a cylinder which surrounds it. The cylinder is, in the region of a cylinder opening of the crankcase, fastened to the crankcase by threaded bolts. At that end of the cylinder which is situated opposite from the cylinder opening, the cylinder is closed off by a cylinder head. The cylinder head contains inlet and outlet valves for the intake and discharge of the compressed air.

As is generally known, in order to assemble the crank drive, that is to say in order to assemble the at least one connecting rod on the crankshaft, either the crankcase is of split design in order that the pre-assembled modular unit of the crankshaft with the connecting rod can be inserted into said crankcase or, on the other hand, it is also possible, as in the above-cited prior art, for the connecting rod to be split in the region of the connecting rod head, so that after the insertion of the crankshaft into a then single-piece, that is to say closed crankcase, the assembly of the connecting rod on the crankshaft can take place. Such an assembly usually takes place with the aid of screws. Since both known alternative assembly methods assume that the crankcase or the connecting rod are of split design, a correspondingly high level of production-related expenditure is required as a result of the milling of contact faces of the crankcase or of the connecting point on the connecting rod head. In addition, corresponding threaded bores must be produced for the screw connections, and additional components such as seals and screws are necessary.

The present disclosure relates to minimizing the production-related expenditure and to permit simplified assembly of a crank drive for a piston compressor.

Thus, the present disclosure relates to a method for assembling a crank drive and also relates to a piston compressor.

The present disclosure, as noted above, relates to a method for assembling a crank drive. The crank drive comprises a crankshaft and at least one connecting rod inserted into a crankcase. The method steps, according to the present disclosure, comprise:

a single-piece connecting rod is inserted through a cylinder opening of the single-piece crankcase;

a crankshaft is inserted through a crankshaft bearing opening of the single-piece crankcase;

the crankshaft is threaded, with an end situated in the interior space of the crankcase, into an opening of the connecting rod head; and

the threading continues until the connecting rod is situated in the assembled position relative to the crankshaft and forms a press fit with the connecting rod bearing seat of the crankshaft.

An advantage of the method according to the present disclosure is that splitting of the crankcase and/or connecting rod for the assembly of the crank drive can be dispensed with entirely. For the threading, according to the present disclosure, of the end of the crankshaft into the opening of the connecting rod head in the interior space of the crankcase, the cylinder opening and the crankshaft bearing opening are to be dimensioned correspondingly. The crankshaft bearing opening is provided for the insertion of the crankshaft bearing. The requirement for assembly by threading is of course to be taken into consideration in the design of the crankshaft. As a result of a split crankcase and/or a split connecting rod being dispensed with, the piston compressor, according to the present disclosure, takes up less installation space overall, since less material is required for threaded bores in the crankcase. It is otherwise not important whether the crankshaft is inserted through the crankcase opening into the interior space of the crankcase first or the connecting rod is inserted through the cylinder opening first.

According to other embodiments of the present disclosure, it is provided that a stroke pin bearing, which is provided between the connecting rod bearing seat of the crankshaft and the connecting rod head of the connecting rod, is pre-assembled on the crankshaft or on the connecting rod before the crankshaft and connecting rod are inserted into the interior space of the crankcase. If the piston compressor is configured or constructed as a dry-running compressor, it is possible for the stroke pin bearing to be configured as a permanently-lubricated rolling bearing. A simple assembly is obtained if the stroke pin bearing is first assembled on the connecting rod before the connecting rod together with the stroke pin bearing is assembled onto the crankshaft by the bearing inner ring of the stroke pin bearing. Depending on the space conditions present in the interior space of the crankcase, any of the embodiments can however be expedient.

In single-cylinder compressors, dynamic balancing weights are provided on the crankshaft, which balancing weights reduce the tendency of the crank drive to oscillate during operation. Such counterweights would however prevent the threading, according to the present disclosure, of the connecting rod onto the crankshaft. It is therefore within the scope of the present disclosure that balancing weights, if required, are detachably fastened to the crankshaft and can be fixed to the crankshaft by being screwed on.

The single-piece crankcase may be produced by primary shaping. The crankcase can be composed of cast iron or aluminium alloys. As a result of the production by primary shaping, for example, casting, and the minimum amount of cutting finishing required with regard to the method or the piston compressor according to the present disclosure, the crankcase can be produced in a simple manner.

Other aspects of the present disclosure will become apparent from the following descriptions when considered in conjunction with the accompanying drawings.

### BRIEF DESCRIPTION OF THE DRAWINGS

FIG. 1 is a longitudinal section through a single-cylinder piston compressor, according to the present disclosure.

FIG. 2 is a diagrammatic illustration of a method for assembling a crank drive at a beginning of assembly, according to the present disclosure.

FIG. 3 is a diagrammatic illustration of the method for assembling a crank drive, at the end of assembly, according to the present disclosure.

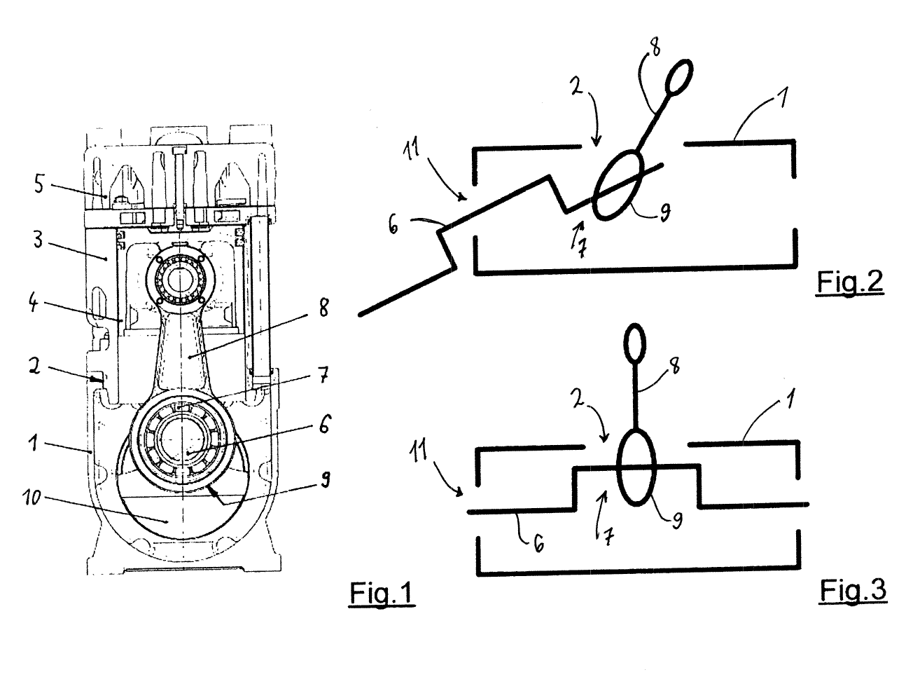

A dry-running piston compressor is shown in FIG. 1. The compressor includes a non-split crankcase 1, a cylinder opening 2 to which a cylinder 3 is attached, and a piston 4 which is axially guided in the cylinder 3. The cylinder 3 is closed off by a cylinder head 5. A crankshaft 6 is rotatably mounted within the crankcase 1. In order to form a crank drive, the crankshaft 6 interacts, by a stroke or crank pin bearing 7, in the form of a permanently-lubricated rolling bearing, with a single-piece, non-split connecting rod 8 by a connecting rod head 9 of the connecting rod 8. In addition, the crankshaft 6 supports dynamic balancing weights 10 which are screwed to the crankshaft 6.

FIG. 2 illustrates a schematic longitudinal view of the piston compressor, according to the present disclosure. To assemble the crank drive, the single-piece connecting rod 8 may be first inserted through the cylinder opening 2 of the single-piece crankcase 1. The crankshaft 6 is subsequently inserted through a crankshaft bearing opening 11 of the crankcase 1 into an interior space in such a way that an inner end of the crankshaft 6 within the crankcase 1 can be threaded into an opening of the connecting rod head 9 of the connecting rod 8. For this purpose, the crankshaft 6 is shaped such that the opening of the connecting rod head 9, which is already pre-assembled with the stroke pin bearing 7 (not shown in detail) can be threaded up to a connecting rod bearing seat of the crankshaft 6.

As shown or suggested in FIG. 3, the connecting rod 8 is situated in a fully-assembled position relative to the crankshaft 6, with the connecting rod 8 forming, by the stroke or crank pin bearing 7, a press fit with the crankshaft 6. The press fit is realized by corresponding fitting dimensions of the components which are to be connected. In order to facilitate assembly, the connecting rod 8 can be heated, so that it is temporarily expanded. In addition, the crankshaft 6 can also be cooled, so that the material correspondingly contracts slightly during assembly.

The present disclosure is not limited to the embodiments described above. It is within the scope of the present disclosure that a twin-cylinder piston compressor can also be produced and assembled by the method for assembling the crank drive. It is within the scope of the present disclosure to use non-split connecting rods and a non-split crankcase. If an intermediate bearing is used for mounting the crankshaft of the twin-cylinder piston compressor, which intermediate bearing is situated between the two crank drives on the crankshaft, the intermediate bearing can, as it is pressed in, be supported against an intermediate wall of the crankcase.

Although the present disclosure has been described and illustrated in detail, it is to be clearly understood that this is done by way of illustration and example only and is not to be taken by way of limitation. The scope of the present disclosure is to be limited only by the terms of the appended claims.

1-8. (canceled)

9. A piston compressor, comprising:
a crankcase including an interior space;
a crankshaft;
at least one connecting rod including a connecting rod head that interacts with the crankshaft, the at least one connecting rod and crankshaft being arranged in the crankcase;
the crankcase and the at least one connecting rod are of a non-split configuration to permit assembly of the at least one connecting rod on the crankshaft by a threading into the interior space of the crankcase;
the crankcase further including a cylinder opening configured to allow mounting of a separate cylinder and inserting of the at least one connecting rod, and the crankshaft further including a crankshaft bearing opening configured to allow inserting of a crankshaft bearing; and
wherein the cylinder opening and the crankshaft bearing opening being dimensioned such that the at least one non-split connecting rod and the crankshaft can be inserted obliquely into the crankcase.

10. The piston compressor as claimed in claim 9, wherein the crankshaft is shaped such that a stroke pin bearing of the at least one connecting rod can be threaded onto a connecting rod bearing seat of the connecting rod from at least one end of the crankshaft.

11. The piston compressor as claimed in claim 9, wherein the at least one connecting rod is a single connecting rod, and the crankshaft and the single connecting rod comprise a single cylinder.

12. The piston compressor as claimed in claim 9, wherein the at least one connecting rod includes two connecting rods, and the crankshaft and the two connecting rods comprise twin cylinders.

13. The piston compressor as claimed in claim 9, wherein the non-split crankcase configuration is produced by primary shaping and is made of cast iron.

14. The piston compressor as claimed in claim 9, wherein the non-split crankcase is produced by primary shaping and is made of an aluminum alloy.
